(19) United States
(12) Patent Application Publication
(10) Pub. No.: US 2026/0204772 A1
(43) Pub. Date: Jul. 16, 2026

(54) Omnidirectional array antenna

(71) Applicant: VIETTEL GROUP, Hanoi City (VN)

(72) Inventors: THI KIM NGAN NGUYEN, Hanoi City (VN); CONG KIEN DINH, Hanoi City (VN); MINH TUAN VU, Hanoi City (VN); HUU TUNG DANG, Hanoi City (VN); HONG HUY THONG NGUYEN, Hanoi City (VN)

(73) Assignee: VIETTEL GROUP, Hanoi City (VN)

(21) Appl. No.: 19/433,721

(22) Filed: Dec. 27, 2025

(30) Foreign Application Priority Data
Dec. 27, 2024 (VN) 1-2024-09788

(51) Int. Cl. H01Q 1/28; H01Q 9/42

(52) U.S. Cl. CPC H01Q 1/28; H01Q 9/42

(57) ABSTRACT

The present invention comprises an omnidirectional antenna array applicable to unmanned aerial vehicles (UAVs) to enhance communication range and signal reliability under adverse terrain or weather conditions, while maintaining compact size, lightweight structure, and omnidirectional radiation capability. The antenna comprises two monopole elements exhibiting omnidirectional radiation, which are fed with a 180-degree phase difference through a slot-to-microstrip transition structure. By arraying two monopole elements and feeding them with a 180-degree phase shift, the antenna achieves high gain and omnidirectional radiation performance, while preserving a small physical size and low mass suitable for installation on UAV platforms.

### FIELD OF THE INVENTION

The present invention relates to an omnidirectional array antenna. Specifically, the omnidirectional array antenna of the invention features high gain, compact size, and is designed for applications in unmanned aerial vehicles (UAVs).

### DESCRIPTION OF THE RELATED ART

In recent years, the use of unmanned aerial vehicles (UAVs) in both civilian and military applications has become a global development trend. The antenna system mounted on UAVs plays a crucial role in maintaining a reliable communication link between the UAV and the ground control station. For antennas used on UAV platforms, there are several requirements such as wide bandwidth, high gain, 360-degree beam coverage in the azimuth plane, compact dimensions, and ease of fabrication. Various solutions have been proposed to satisfy these demanding requirements.

Omnidirectional antennas are widely used in communication systems for unmanned aerial vehicles (UAVs); however, they still exhibit several limitations that remain to be addressed. For instance, quarter-wavelength monopole antennas and half-wavelength dipole antennas can generate 360-degree radiation coverage in the azimuth plane with a compact and easily fabricated structure, yet they suffer from narrow bandwidth and low gain. Similarly, biconical antennas provide wideband operation and omnidirectional radiation patterns, but they exhibit low gain and large physical dimensions. The series-fed antenna array is another approach for achieving higher gain; however, it typically results in a large size and very narrow bandwidth. Furthermore, vertically distributed antenna arrays can achieve broadband performance and high gain, but it remains challenging for such configurations to maintain uniform 360-degree radiation in the azimuth plane with minimal pattern variation.

The present invention provides a high-gain omnidirectional array antenna comprising two monopole antennas arranged in an inverted and symmetrical configuration with respect to the center of a dielectric substrate. The two monopole elements are fed by a 180° out-of-phase power divider, in combination with a balancing structure that ensures electromagnetic symmetry. This configuration enables the antenna to achieve wide impedance bandwidth, high gain, and omnidirectional radiation with minimal pattern fluctuation in the azimuth plane. Additionally, the proposed antenna exhibits a compact form factor suitable for integration into unmanned aerial vehicles (UAVs). The use of printed circuit technology facilitates simple and cost-effective fabrication, making the design highly practical for modern UAV communication systems.

### SUMMARY OF THE INVENTION

The primary objective of the invention is to provide a high-gain, compact omnidirectional array antenna suitable for unmanned aerial vehicle (UAV) applications. The invention aims to extend the communication range between the UAV and the ground control station by enhancing the antenna gain, while simultaneously meeting the stringent requirements of small size, lightweight structure, and omnidirectional radiation capability.

To achieve the above objectives, the present invention provides an omnidirectional antenna array comprising two monopole antenna elements exhibiting omnidirectional radiation characteristics. The antenna elements are fed by a feeding network that provides equal amplitude signals with a 180° phase difference, together with a balancing structure to maintain electromagnetic symmetry. By combining two antenna elements in an array configuration and feeding them with a 180° phase shift, the proposed design achieves high antenna gain, while the balancing structure ensures a uniform 360-degree radiation pattern in the azimuth plane with minimal variation. More specifically, the omnidirectional array antenna disclosed in the present invention comprises:
The radiating section comprises two monopole antenna elements printed on the surface of a planar dielectric substrate. By employing printed circuit antenna technology, the overall size and weight of the antenna mounted on the unmanned aerial vehicle (UAV) are effectively minimized, ensuring suitability for airborne integration.
The feeding section consists of a 180° out-of-phase power divider designed using printed circuit board (PCB) technology. The feeding network employs microstrip transmission lines integrated with a slot-to-microstrip transition structure, ensuring proper signal excitation for the antenna array while maintaining broadband omnidirectional radiation characteristics.
The transmission line transition section converts the 50-ohm coaxial feed line to a microstrip line, providing a compact, cost-effective, and easy-to-fabricate design.
The balancing structure consists of two conductive strips printed on the opposite side of the dielectric substrate. This structure functions to maintain electromagnetic symmetry, thereby generating a 360-degree radiation pattern in the azimuth plane with minimal variation.

### BRIEF DESCRIPTION OF THE DRAWINGS

FIG. 1 illustrates the front view of the omnidirectional array antenna structure.

FIG. 2 illustrates the rear view of the antenna structure.

FIG. 3 illustrates the rear view of the antenna structure prior to soldering the coaxial feed cable.

FIG. 4 illustrates the side view of the antenna structure, showing an enlarged view of the transmission line transition section.

FIG. 5 illustrates the reflection coefficient (S11) of the proposed antenna.

FIG. 6 illustrates the radiation patterns of the antenna in the E-plane and H-plane at the frequency of 4.8 GHz.

### DETAILED DESCRIPTION

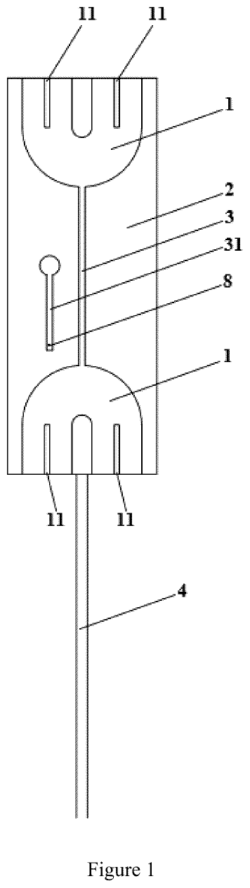

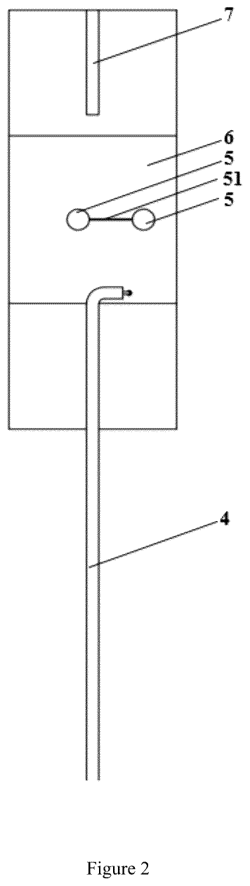

In the present invention, with reference to FIGS. 1 and 2, the high-gain omnidirectional array antenna for unmanned aerial vehicle (UAV) applications comprises the following main components: a radiating section, a feeding section, a transmission line transition section, and a balancing section. The detailed configuration of each component is described as follows:

The radiating section of the omnidirectional array antenna comprises two monopole antenna elements (1) of identical dimensions. Each monopole element (1) has a U-shaped configuration and is coplanarly printed on a planar dielectric substrate (2). The two monopole elements are inverted and symmetrically arranged with respect to the center of the dielectric substrate (2), thereby achieving high antenna gain and omnidirectional radiation performance over a wide frequency bandwidth. Each monopole element (1) includes rectangular slots (11) that function to reduce gain variation between horizontal directions and to enhance the omnidirectional characteristics of the antenna. The dielectric substrate (2) has a rectangular shape with a small thickness, which helps minimize dielectric loss and reduce the antenna volume. The overall dimensions of the substrate are maintained below 80 mm×30 mm, and the total antenna weight is kept below 100 grams when integrated onto an unmanned aerial vehicle (UAV) platform.

The feeding section is implemented as a 180° out-of-phase power divider based on a slot-to-microstrip transition structure. It comprises a first microstrip line (3) that directly feeds the two monopole antenna elements (1) and a second microstrip line (31), which consists of a circular segment connected to an elongated rectangular strip. The second microstrip line (31) is electromagnetically coupled in parallel with the first microstrip line (3). On the opposite side of the dielectric substrate (2), a circular slot (5) is etched on the ground plane (6). The circular slot (5) includes two circular apertures interconnected by a narrow slot section (51). By employing this slot-to-microstrip transition feeding configuration, the two monopole elements (1) are excited with equal amplitude and 180-degree phase difference, ensuring impedance matching and maintaining the omnidirectional radiation pattern over the operating frequency range.

Referring to FIGS. 2, 3, and 4, the invention employs a transmission line transition section comprising a coaxial cable (4), whose inner conductor (41) is soldered to the second microstrip line (31) through a hole (8) of appropriate diameter drilled through the dielectric substrate (2). This configuration ensures a 50-ohm impedance transformation from the coaxial cable to the second microstrip line (31). The structure enables a compact antenna size, cost-effectiveness, and ease of fabrication.

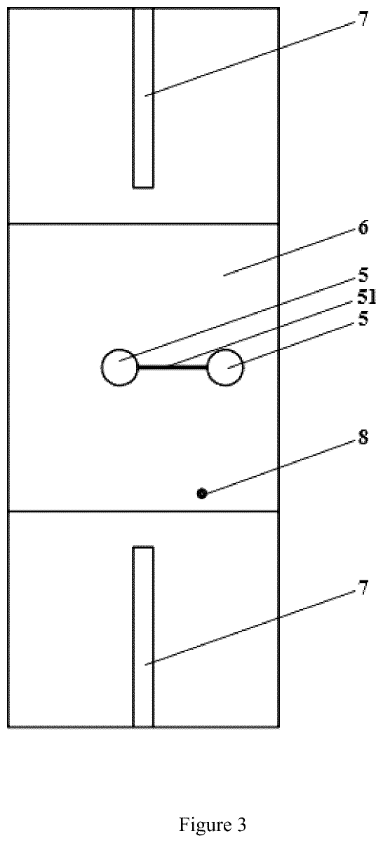

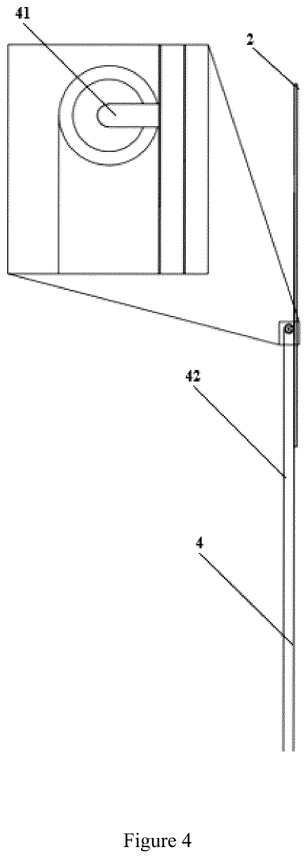

Referring to FIG. 3, the balancing section comprises two conductive strips (7) printed coplanar with the ground plane (6). These conductive strips (7) serve to enhance the radiation symmetry of the two-element monopole antenna array, ensuring that the omnidirectional radiation pattern of the antenna is not affected by the coaxial cable (4). This configuration enables the antenna to maintain a 360-degree radiation pattern in the azimuth plane with minimal variation. Referring to FIG. 4, a portion of the outer conductor (42) of the coaxial cable (4) is soldered to the ground plane (6) to provide electrical grounding, while another portion of the outer conductor (42) is soldered to the conductive strip (7). This mechanical connection serves to mechanically stabilize the coaxial cable relative to the antenna structure, thereby preventing distortion of the antenna's radiation characteristics.

### Execution Example

FIG. 5 shows the reflection coefficient within the operating frequency range of 4-5.5 GHz. The reflection coefficient is defined as the ratio of the reflected power to the incident power when the antenna is fed at a specific port. As shown in FIG. 5, the reflection coefficient remains below −10 dB across the operating frequency range. A low reflection coefficient indicates good impedance matching between the radiator and the feeding structure.

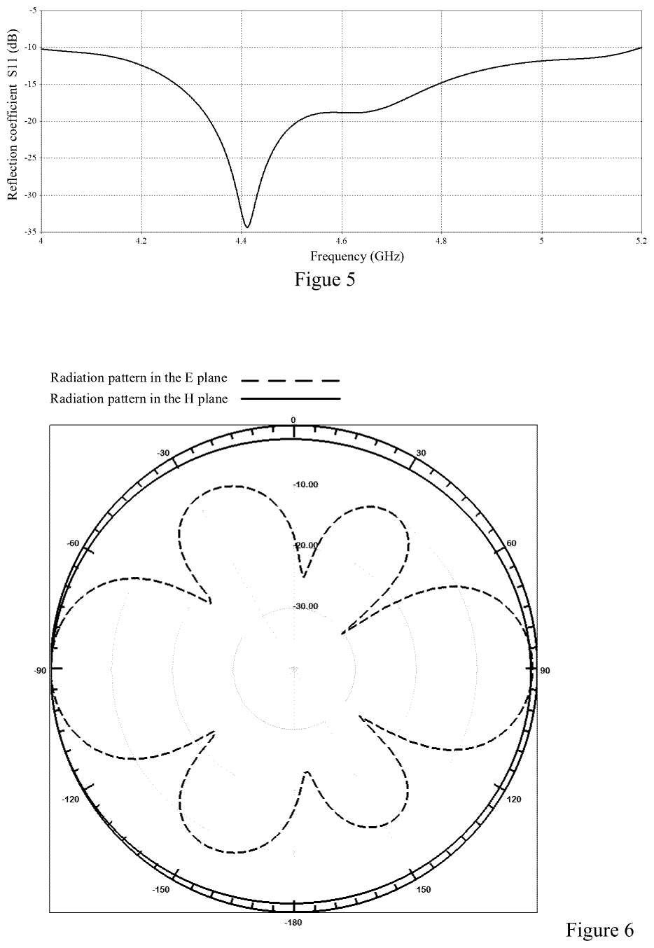

FIG. 6 illustrates the radiation patterns of the compact, high-gain omnidirectional array antenna in the E-plane and H-plane at 4.8 GHz. The radiation patterns illustrate the omnidirectional radiation capability of the antenna in space. For antennas used in unmanned aerial vehicle (UAV) applications, it is essential that the antenna can transmit and receive signals over a wide spatial range and ensure extended communication range. In the present design, the antenna achieves omnidirectional radiation characteristics and high gain, thereby ensuring a long communication range between the UAV and the ground control station.

What is claimed is:

1. An omnidirectional antenna array, comprising:
a radiating section comprising two monopole antennas having identical dimensions, each of the monopole antennas being coplanarly printed in a U-shape and arranged in an inverted symmetrical configuration about a center of a dielectric substrate, the configuration being configured to provide high gain and broadband omnidirectional radiation, each of said monopole antennas including two rectangular slots configured to reduce gain variation between horizontal directions and to enhance omnidirectional radiation characteristics, the dielectric substrate being configured to reduce dielectric loss and antenna volume and having dimensions less than 80 mm×30 mm and a total weight less than 100 grams;
a feeding section configured as a 180-degree out-of-phase power divider having a slot-to-microstrip transition structure, the feeding section comprising a first microstrip line directly feeding the two monopole antennas, a second microstrip line having a circular segment connected to an elongated rectangular strip, the second microstrip line being electromagnetically coupled in parallel with the first microstrip line, and a circular slot formed on an opposite side of the dielectric substrate, the circular slot having two circular apertures interconnected by a narrow slot section and located on a ground plane;
a transmission line transition section comprising a coaxial cable having an inner conductor soldered to the second microstrip line through a hole of a diameter selected to provide impedance matching drilled through the dielectric substrate, the transition section being configured to provide a 50-ohm impedance transformation between the coaxial cable and the second microstrip line;
a balancing section comprising two conductive strips printed coplanar with the ground plane, the balancing section being configured to enhance symmetry of a radiation pattern of the two-element monopole antenna array and to maintain an omnidirectional radiation pattern independently of the coaxial cable, wherein a portion of an outer conductor of the coaxial cable is soldered to the ground plane to provide electrical grounding, and another portion of the outer conductor is soldered to one of the conductive strips to mechanically secure the coaxial cable relative to the antenna, the balancing section being further configured to prevent deformation of the radiation pattern.
